(19) United States
(12) Patent Application Publication
(10) Pub. No.: US 2009/0179801 A1
(43) Pub. Date: Jul. 16, 2009

(54) Dual-band antenna

(75) Inventors: Tiao-Hsing Tsai, Taipei Shien (TW); Chao-Chiang Kuo, Tao Yuan Shien (TW); Tsung-Ming Kuo, Tainan City (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Quanta Computer Inc., Tao Yuan Shien (TW)

(21) Appl. No.: 12/220,174

(22) Filed: Jul. 21, 2008

(30) Foreign Application Priority Data
Jan. 16, 2008 (TW) 097101650

(51) Int. Cl. H01Q 9/04; H01Q 11/12

(52) U.S. Cl. 343/700 MS; 343/741

(57) ABSTRACT

An antenna includes a loop unit and an arm unit. The loop unit includes a grounding element that extends along a first plane, a feeding element that extends along a second plane, and a radiating element that interconnects the feeding element and the grounding element. The arm unit extends from the feeding element of the loop unit.

### CROSS-REFERENCE TO RELATED APPLICATION

This application claims priority of Taiwanese application no. 097101650, filed on Jan. 16, 2008.

### BACKGROUND OF THE INVENTION

1. Field of the Invention

This invention relates to an antenna, more particularly to a dual-band planar inverted-F antenna (PIFA).

2. Description of the Related Art

In U.S. Pat. No. 6,861,986, there is disclosed a conventional antenna device for a portable electronic device that includes a radiating element, a grounding element, and an interconnecting element. The radiating element has a first radiating portion, and a second radiating portion that is opposite to and has a length longer than the first radiating portion thereof. The interconnecting element includes a first end that is connected to a junction of the first and second radiating portions of the radiating element, a second end that is connected to the grounding element, and a middle portion that interconnects the first and second ends thereof. The first radiating portion of the radiating element, the grounding element, and the interconnecting element constitute a first planar inverted-F antenna (PIFA) that is operable in a high frequency range. The second radiating portion of the radiating element, the grounding element, and the interconnecting element constitute a second PIFA that is operable in a low frequency range.

The aforementioned conventional antenna device is disadvantageous in that it has a relatively large physical size. Moreover, when adjusting the length of the first radiating portion of the radiating element to tune the first PIFA, the length of the second radiating portion of the radiating element has to be adjusted as well. Similarly, when adjusting the length of the second radiating portion of the radiating element to tune the second PIFA, the length of the first radiating portion of the radiating element has to be adjusted as well. This causes inconvenience on the part of the designer of the conventional antenna device.

### SUMMARY OF THE INVENTION

Therefore, the object of the present invention is to provide an antenna that can overcome the aforesaid drawbacks of the prior art.

According to the present invention, an antenna comprises a loop unit and an arm unit. The loop unit includes a flat grounding element that extends along a first plane, a flat feeding element that extends along a second plane transverse to the first plane, and a flat radiating element that extends along the second plane and that interconnects the feeding element and the grounding element. The arm unit extends from the feeding element of the loop unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an antenna according to this invention;

FIG. 2 is a perspective view illustrating a gap between a feeding element and a grounding element of the preferred embodiment;

FIG. 3 is a plot illustrating a voltage standing wave ratio (VSWR) of the preferred embodiment;

FIG. 4 shows plots of radiation patterns of the preferred embodiment respectively on the x-y, x-z, and y-z planes when operated at 2437 MHz; and

FIG. 5 shows plots of radiation patterns of the preferred embodiment respectively on the x-y, x-z, and y-z planes when operated at 5350 MHz.

### DETAILED DESCRIPTION OF THE PREFERRED EMBODIMENT

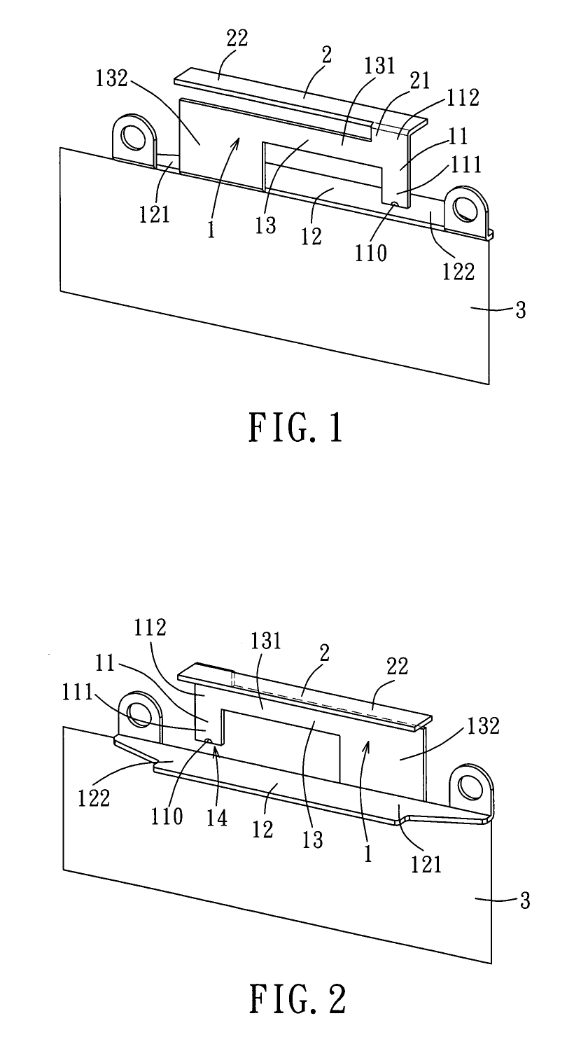

Referring to FIG. 1, the preferred embodiment of an antenna according to this invention is shown to include a loop unit 1 and an arm unit 2.

The antenna of this invention is a dual-band planar inverted-F antenna (PIFA), has a relatively small physical size, and is applicable to a portable electronic device (not shown), such as a notebook computer or a mobile phone.

The loop unit 1 has an effective length of one-half wavelength in a first frequency range from 2400 MHz to 2700 MHz, and includes a flat grounding element 12, a flat feeding element 11, and a flat radiating element 13. The grounding element 12 extends along a first plane, and has opposite first and second end portions 121, 122. The feeding element 11 extends along a second plane transverse to the first plane, is generally rectangular in shape, is disposed above and overlaps the second end portion 122 of the grounding element 12, and has opposite first and second end portions 111, 112 that are respectively disposed proximate to and distal from the grounding element 12. The radiating element 13 extends along the second plane, is generally L-shaped, and has transverse first and second radiating portions 131, 132. The first radiating portion 131 of the radiating element 13 extends from an edge of the second end portion 112 of the feeding element 11. The second radiating portion 132 of the radiating element 13 extends from an edge of the first end portion 121 of the grounding element 12. In this embodiment, the feeding element 11, the grounding element 12, and first and second radiating portions 131, 132 of the radiating element 13 of the loop unit 1 cooperatively form an open loop. Moreover, in this embodiment, the first end portion 111 of the feeding element 11 and the second end portion 122 of the grounding element 12 cooperatively define a gap 14 therebetween, as best shown in FIG. 2. Further, in this embodiment, the first end portion 111 of the feeding element 11 is provided with a feeding point 110 at a free end thereof.

The feeding point 110 is connected to a signal source (not shown) of a circuit (not shown) of the electronic device.

The arm unit 2 has an effective length of one-quarter wavelength in a second frequency range from 4900 MHz to 5900 MHz and is disposed above and overlaps the grounding element 12. In particular, the arm unit 2 is generally L-shaped, and includes transverse first and second flat parts 21, 22. The first flat part 21 of the arm unit 2 extends along the second plane from a junction of the second end portion 112 of the feeding element 11 and the first radiating portion 131 of the radiating element 13. The second flat part 22 of the arm unit 2 extends along a third plane parallel to the first plane from the first flat part 21 of the arm unit 2. In this embodiment, the first and second flat parts 21, 22 of the arm unit 2 and the first radiating portion 131 of the radiating element 13 of the loop unit 1 cooperatively form another open loop.

The antenna further includes a copper foil 3 connected to the grounding element 12 of the loop unit 1. The construction as such enlarges an area of the grounding element 12.

TABLE I

| | | Efficiency | Efficiency | H-plane |
|---|---|---|---|---|
| Frequency (MHz) | | (dB) | (%) | Avg. Gain(dBi) |
| 802.11 b/g | 2412 | −3.94 | 40.4 | −2.23 |
| | 2437 | −3.41 | 45.6 | −2.83 |
| | 2462 | −3.24 | 47.4 | −2.35 |
| | 2500 | −3.32 | 46.6 | −2.73 |
| | 2600 | −3.68 | 42.9 | −2.82 |
| | 2700 | −3.90 | 40.7 | −3.01 |
| 802.11 a | 4900 | −4.18 | 38.2 | −3.77 |
| | 5150 | −3.57 | 44.0 | −2.41 |
| | 5350 | −2.77 | 52.8 | −3.05 |
| | 5470 | −2.83 | 52.1 | −2.81 |
| | 5725 | −3.43 | 45.4 | −2.11 |
| | 5875 | −3.74 | 42.3 | −3.01 |

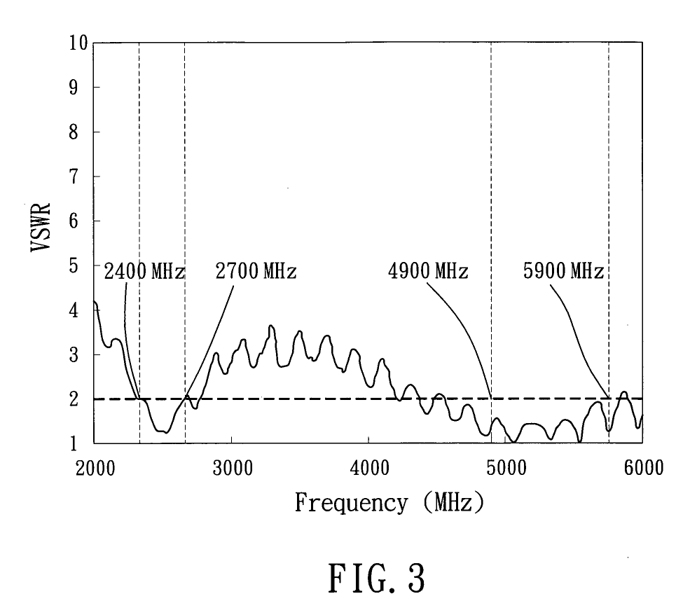

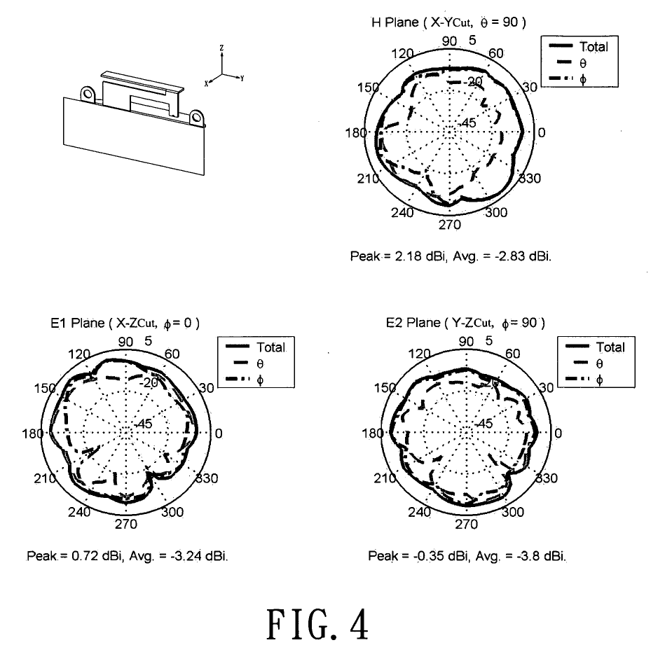

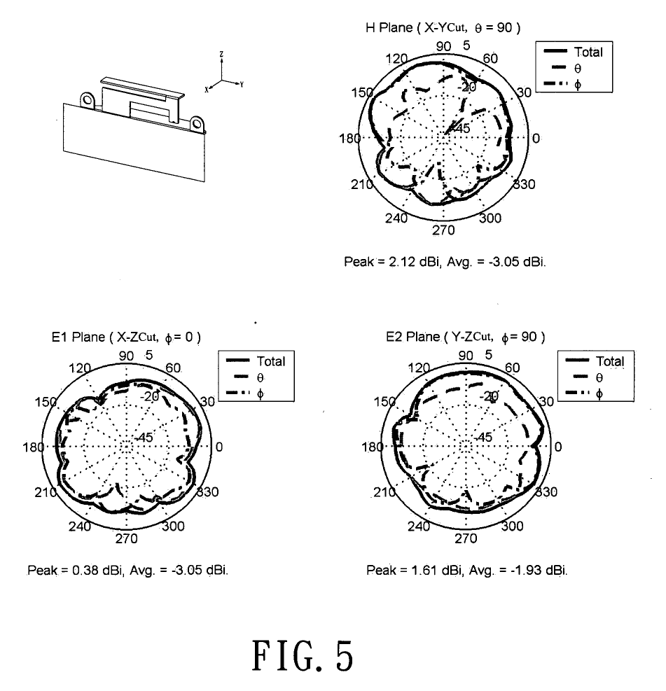

Experimental results, as illustrated in FIG. 3, show that the antenna of this invention achieves a voltage standing wave ratio (VSWR) of less than 2.0 in the first and second frequency ranges. Moreover, as shown in Table I, the antenna of this invention achieves a minimum efficiency of 38.2% in the first and second frequency ranges. Further, as illustrated in FIGS. 4 and 5, the loop unit 1 and the arm unit 2 of the antenna of this invention has substantially omnidirectional radiation patterns when operated at 2437 MHz and 5350 MHz, respectively.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna comprising:
a loop unit including
a flat grounding element that extends along a first plane,
a flat feeding element that extends along a second plane transverse to the first plane, and
a flat radiating element that extends along the second plane and that interconnects said feeding element and said grounding element; and
an arm unit extending from said feeding element of said loop unit.

2. The antenna as claimed in claim 1, wherein said loop unit has an effective length of one-half wavelength in a first frequency range, and said arm unit has an effective length of one-quarter wavelength in a second frequency range higher than the first frequency range.

3. The antenna as claimed in claim 1, wherein said loop unit forms an open loop.

4. The antenna as claimed in claim 1, wherein said feeding element is disposed above and overlaps said grounding element, and has opposite first and second end portions that are respectively proximate to and distal from said grounding element, said antenna further comprising a feeding point provided on said first end portion of said feeding element.

5. The antenna as claimed in claim 4, wherein said arm unit extends from said second end portion of said feeding element and is disposed above and overlaps said grounding element.

6. The antenna as claimed in claim 1, wherein said arm unit includes a first flat part that extends along the second plane from said feeding element, and a second flat part that extends transversely from said first flat part thereof along a third plane parallel to the first plane.

7. The antenna as claimed in claim 1, wherein said arm unit and said radiating element of said loop unit cooperatively form an open loop.

8. The antenna as claimed in claim 1, wherein said radiating element is generally L-shaped.

9. The antenna as claimed in claim 1, wherein said feeding element is generally rectangular in shape.

10. The antenna as claimed in claim 1, further comprising a copper foil connected to said grounding element.

11. The antenna as claimed in claim 2, wherein the first frequency range is from 2400 MHz to 2700 MHz.

12. The antenna as claimed in claim 2, wherein the second frequency range is from 4900 MHz to 5900 MHz.
